(19) United States
(12) Patent Application Publication
(10) Pub. No.: US 2017/0309225 A1
(43) Pub. Date: Oct. 26, 2017

(54) APPARATUS WITH OLED DISPLAY AND OLED DRIVER THEREOF

(71) Applicants: Chih-Ta Star Sung, HsinChu (TW); Yin-Chun Lan, Miaoli County (TW); Yen Chuo, Taipei (TW)

(72) Inventors: Chih-Ta Sung, HsinChu (TW); Yin-Chun Lan, HsinChu (TW); Yen Chuo, HsinChu (TW)

(21) Appl. No.: 15/134,400

(22) Filed: Apr. 21, 2016

(51) Int. Cl. G09G 3/3208

(52) U.S. Cl. CPC G09G 3/3208; G09G 2330/021

(57) ABSTRACT

An OLED apparatus has an OLED driver for receiving display data from a processor. The processor gets OLED status information indicating attenuation or other status of OLED cells or related circuits. The processor calculates adjustment data according to the OLED status information and sends the adjustment data to the OLED driver. The OLED driver drives the OLED cells based on the adjustment data to overcome attenuation and other related problems.

### FIELD OF THE INVENTION

The present invention is related to an apparatus with a display and a driver thereof and more particularly related to an apparatus with an OLED display and an OLED driver thereof.

### BACKGROUND

Electronic displays are more and more important in today life. From CRT displays used as an interface between machines and people, LED displays, which provides thinner space and other advantages can be found everywhere in the world. OLED, which means Organic Light-Emitting Diode, displays have lower power consumption and other advantages are becoming more and more popular.

Nevertheless, there are accompanied problems necessary to handle to make such technology more acceptable in human life to make human life more colorful.

### SUMMARY OF INVENTION

An OLED apparatus includes OLED cells, an OLED driver and a processor. The OLED driver drives the OLED cells for rendering an image. For example, the OLED driver may generate necessary current or signals to drive a power circuit to generate necessary current to OLED cells to control light volume of each OLED cell together to display a corresponding visible picture of the image. Examples of such OLED device may include a mobile phone, a wearable device, a tablet computer, a portable device, a laptop computer or any electronic device that has an OLED display.

The OLED driver may be implemented as a module like an integrated circuit chip (IC) or integrated with the power circuit as mentioned above to be packed as an IC. Alternatively, the OLED driver and the processor may be integrated in a package or designed as separate modules or ICs. The processor may refer to one or more than one processing or controlling circuit with or without corresponding software or firmware to determine the working logic of the OLED apparatus.

The OLED driver may include a status extraction device and a compensation device. The status extraction device obtains OLED status information of the OLED cells. The compensation device receives adjustment data and uses the adjustment data to adjust the driving of the OLED cells.

In other words, instead of handling compensation completely in the OLED driver, the OLED driver sends corresponding information to the processor. The processor processes the OLED status information to generate corresponding adjustment data. The adjustment data are then sent to the OLED driver so that the OLED driver drives the OLED cells based on the adjustment data. Such adjustment may due to attenuation of OLED cells or associated circuits or any permanent or temporary distortion due to any other reasons like operating temperature or signal interference.

The processer generates the image. The image may refer to one image or a series of images that form visual interface of the OLED apparatus or a video. As mentioned above, the processor may include more than one actual processor units. For example, a processor in a mobile phone may include multi-core processors. One core may be used for rendering video while another core may be dispatched for handling OLED compensation as mentioned above. Alternatively, a separate controller or circuit may be provided to execute the compensation function receiving the OLED status information, for generating the adjustment and still be called as part of the processor. The processor generates the adjustment data based on the OLED status information and sends the adjustment data to the OLED driver. In other word, part or complete calculation of compensation work is handled by the processor. The adjustment data may be in the form that is directly used for adjusting the driving of the OLED cells. Alternatively, the adjustment data may be further processed by the OLED driver before being used for driving the OLED cells. Such various implementation options are all covered within the invention scope.

In addition, the adjustment data are compressed when being send to the OLED driver. In other words, the adjustment data, before being send to the OLED driver, may be compressed by the processor or other related circuit to minimize their size. When the adjustment data are needed, they are decompressed and used.

As mentioned above, the processor may have multiple circuits. One or more than one of the multiple circuits is responsible for generating the image, even for handling communication tasks like in mobile phone device. Another of the multiple circuits is responsible for generating the adjustment data. Task dispatching among these circuits may be predetermined in advance or be adjusted dynamically during operation of the OLED apparatus.

In one embodiment, the processor may be the main processor of the OLED apparatus like the main processor in a mobile phone. In other words, the processor is a different and separate module from the OLED driver. The main processor does not only handle the compensation of the OLED cells but also handle most other processing tasks necessary to provide major function like to communicate in a mobile phone application. The OLED driver may be a module connected with the main processor via a signal interface like a serial port interface or a parallel signal interface. Other connection methods between the OLED driver and the processor are also applicable once they provide signal exchange between the processor and the OLED driver.

The OLED apparatus may also include storage for storing reference data to be compared with the OLED status information for generating the adjustment data. Such storage may be various kinds of memory devices like a DRAM, a flash memory, a register set, or any other memory circuit. Such storage may be integrated in the OLED driver, as a separate module or multiple modules, or any form once such storage is accessible by the processor for handling the compensation work. In other words, the storage may be allocated specifically for the compensation work or just be shared with other function. This means in some embodiments, the OLED driver does not need to keep a specific memory for handling the compensation work and that helps reducing cost and product reliability.

In addition, the reference data are compressed when being stored in the storage. In other words, the reference data, before being stored in the storage, may be compressed by the processor or the OLED driver or other related circuit to minimize their size. When the reference data are needed, they are decompressed and used. For cases of attenuation due to OLED cells or associated circuits, there are usually patterns or nature for achieving compression skills based thereon.

As mentioned above, the storage may be located outside the OLED driver and may also be used for storing other data used by the processor for functions other than OLED displaying.

The status extraction device may include an analog-to-digital converter for converting analog data related to drive the OLED cells to digital values to send to the processor for generating the adjustment data. For example, the actual current for driving the OLED cells may be collected as an analog information. The analog information may be converted into associated digital values. The digital values are then sent to the processor for calculating corresponding adjustment data for compensation. Please be noted that such analog information may be associated to each OLED cell separately, be associated to each column of the OLED cells separately, be associated to multiple areas of the OLED cells separately or be associated to any other arrangement related the OLED cells. For example, in an OLED display, different areas may confront different levels of attenuation due to different use or other factors. Such characteristics may be considered to divide the OLED cells into multiple subsets and different compensations are applied to these subsets separately.

The compensation device may include a digital-to-analog converter for converting the adjustment data to analog data related to drive the OLED cells. The compensation device may include other corresponding circuits for achieving the driving function together.

When there are lot of OLED cells, adjustment data may occupy large space. The adjustment data may be compressed by the processor before sending to the OLED driver. When the OLED driver receives the compressed adjustment data, the OLED driver may use a corresponding decompressing circuit to decompress the compressed adjustment data so as to apply corresponding compensation and driving.

Please be noted that such compensation may be applied continuously during driving the OLED cells. Alternatively, such compensation may refer to set values in some registers or tables which are used as reference for generating the output driving signals or driving currents for the OLED cells.

The compensation may be applied periodically, automatically or manually when being requested by the user.

In addition, the OLED status information may include actual driving signal like driving current values and may also include optical information of the light emitted by the OLED cells. To achieve that, some optical sensors may be disposed to get the actual light output and such information is converted or integrated with the OLED status information to be sent to the processor.

In addition, the OLED status information are compressed when being sent to the processor. In other words, the OLED status information, before being sent to the processor, may be compressed by the OLED driver or other related circuit to minimize their size. When the OLED status information are needed, they are decompressed and used.

Another embodiment of the present invention is an OLED driver to be used in an OLED apparatus. In other words, a manufacturer may produce the whole OLED apparatus, part of the OLED apparatus or just the OLED driver by using the inventive schemes as mentioned above.

Compared with applying compensation within the OLED driver, the embodiments mentioned above keep the OLED driver design simpler and thus reduces production cost and complexity. On the other hand, the processor usually has strong computation power while the compensation may not need to computed continuously. The computation work may be applied by the processor during free time or initialization time when the OLED apparatus is started. No further cost is used while the same task is done. In addition, memory saving is also achieved with compression and sharing designs as mentioned above.

### BRIEF DESCRIPTION OF DRAWINGS

FIG. 1 illustrates an embodiment of OLED compensation scheme.

FIG. 2 illustrates an embodiment for implementing compensation.

FIG. 3 illustrates an example of an OLED driver component.

### DETAILED DESCRIPTION

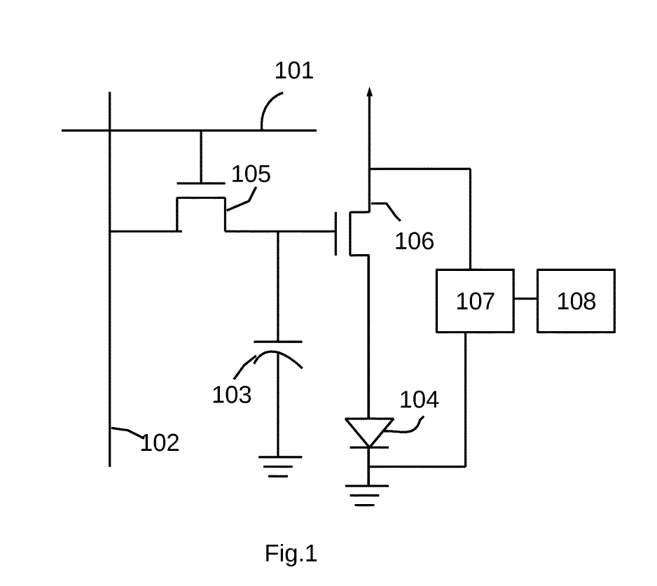

Please refer to FIG. 1, which illustrates an OLED compensation scheme.

The transistor 105 and the transistor 106 are used as a control for an OLED cell. A data line 102 and a scan line 101 are used for carrying control information. The capacitor 103 has a value for determining the illuminant value of the OLED cell. The transistors 105, 106 and other circuits may function abnormally or confront attenuation or distortion problems. In addition, the OLED cell itself may confront attenuation problem. Status information like the actual driving current or voltage may be collected by the compensation unit 107 which uses a storage 108 as a reference to calculate corresponding compensation value.

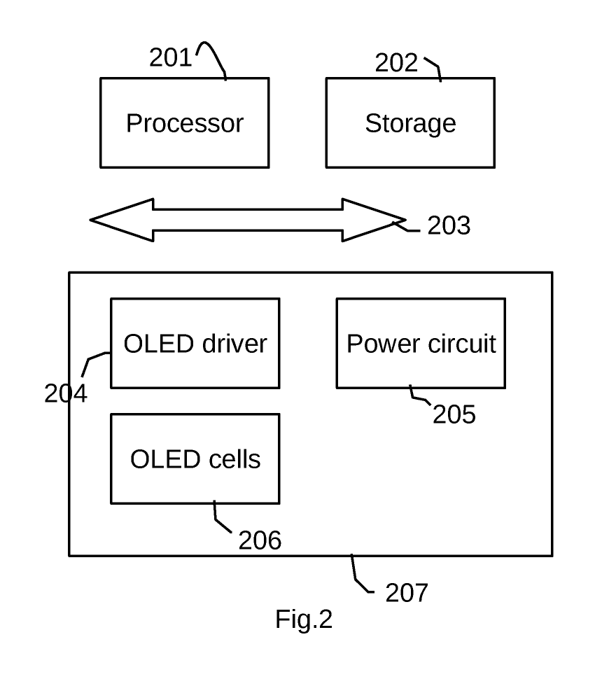

Please refer to FIG. 2, which illustrate an OLED apparatus embodiment. In this embodiment, the OLED apparatus has a processor 201, a storage 202, a signal interface 203, an OLED module that has an OLED driver 204, a power circuit 205 and a plurality of OLED cells 206. Please be noted that this is for illustration of an example, instead of limiting the inventive scope. Such architecture may be used in various designs like a mobile phone, a wearable device, a tablet computer, a laptop computer, or any other electronic devices that has one or more than one OLED displays.

The processor 201 uses the storage 202 to store information that is mentioned below and communicates with the OLED driver 204 via the signal interface 203. The OLED driver 204 generates driving signals to trigger the power circuit 205 to generate output current to drive the OLED cells 206 to emit light as instructed.

The OLED apparatus includes OLED cells 206, the OLED driver 204 and a processor 201. The OLED driver 204 drives the OLED cells 206 for rendering an image. For example, the OLED driver 204 may generate necessary current or signals to drive the power circuit 205 to generate necessary current to OLED cells 206 to control light volume of each OLED cell together to display a corresponding visible picture of the image. Examples of such OLED device may include a mobile phone, a wearable device, a tablet computer, a portable device, a laptop computer or any electronic device that has an OLED display.

The OLED driver 204 may be implemented as a module like an integrated circuit chip (IC) or integrated with the power circuit as mentioned above to be packed as an IC. Alternatively, the OLED driver 204 and the processor 201 may be integrated in a package or designed as separate modules or ICs. The processor 201 may refer to one or more than one processing or controlling circuit with or without corresponding software or firmware to determine the working logic of the OLED apparatus.

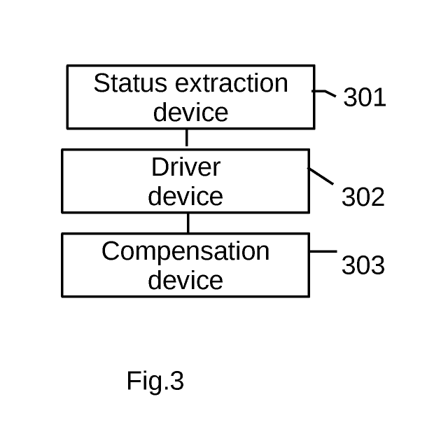

Please refer to FIG. 3, which illustrates an embodiment of an OLED driver. The OLED driver may include a driver device 302 for performing driving signals, a status extraction device 301 and a compensation device 303. The status extraction device 301 obtains OLED status information of the OLED cells. The compensation device 303 receives adjustment data and uses the adjustment data to adjust the driving of the OLED cells.

In other words, instead of handling compensation completely in the OLED driver, the OLED driver sends corresponding information to the processor. The processor processes the OLED status information to generate corresponding adjustment data. The adjustment data are then sent to the OLED driver so that the OLED driver drives the OLED cells based on the adjustment data. Such adjustment may due to attenuation of OLED cells or associated circuits or any permanent or temporary distortion due to any other reasons like operating temperature or signal interference.

The processer generates the image. The image may refer to one image or a series of images that form visual interface of the OLED apparatus or a video. As mentioned above, the processor may include more than one actual processor units. For example, a processor in a mobile phone may include multi-core processors. One core may be used for rendering video while another co re may be dispatched for handling OLED compensation as mentioned above. Alternatively, a separate controller or circuit may be provided to execute the compensation function receiving the OLED status information, for generating the adjustment and still be called as part of the processor. The processor generates the adjustment data based on the OLED status information and sends the adjustment data to the OLED driver. In other word, part or complete calculation of compensation work is handled by the processor. And further more, the adjustment data The adjustment data may be in the form that is directly used for adjusting the driving of the OLED cells. Alternatively, the adjustment data may be further processed by the OLED driver before being used for driving the OLED cells. Such various implementation options are all covered within the invention scope.

In addition, the adjustment data are compressed when being send to the OLED driver. In other words, the adjustment data, before being send to the OLED driver, may be compressed by the processor or other related circuit to minimize their size. When the adjustment data are needed, they are decompressed and used.

As mentioned above, the processor may have multiple circuits. One or more than one of the multiple circuits is responsible for generating the image, even for handling communication tasks like in mobile phone device. Another of the multiple circuits is responsible for generating the adjustment data. Task dispatching among these circuits may be predetermined in advance or be adjusted dynamically during operation of the OLED apparatus.

In one embodiment, the processor may be the main processor of the OLED apparatus like the main processor in a mobile phone. In other words, the processor is a different and separate module from the OLED driver. The main processor does not only handle the compensation of the OLED cells but also handle most other processing tasks necessary to provide major function like to communicate in a mobile phone application. The OLED driver may be a module connected with t0068e main processor via a signal interface like a serial port interface or a parallel signal interface. Other connection methods between the OLED driver and the processor are also applicable once they provide signal exchange between the processor and the OLED driver.

The OLED apparatus may also include storage for storing reference data to be compared with the OLED status information for generating the adjustment data. Such storage may be various kinds of memory devices like a DRAM, a flash memory, a register set, or any other memory circuit. Such storage may be integrated in the OLED driver, as a separate module or multiple modules, or any form once such storage is accessible by the processor for handling the compensation work. In other words, the storage may be allocated specifically for the compensation work or just be shared with other function. This means in some embodiments, the OLED driver does not need to keep a specific memory for handling the compensation work and that helps reducing cost and product reliability.

In addition, the reference data are compressed when being stored in the storage. In other words, the reference data, before being stored in the storage, may be compressed by the processor or the OLED driver or other related circuit to minimize their size. When the reference data are needed, they are decompressed and used. For cases of attenuation due to OLED cells or associated circuits, there are usually patterns or nature for achieving compression skills based thereon.

As mentioned above, the storage may be located outside the OLED driver and may also be used for storing other data used by the processor for functions other than OLED displaying.

The status extraction device may include an analog-to-digital converter for converting analog data related to drive the OLED cells to digital values to send to the processor for generating the adjustment data. For example, the actual current for driving the OLED cells may be collected as an analog information. The analog information may be converted into associated digital values. The digital values are then sent to the processor for calculating corresponding adjustment data for compensation. Please be noted that such analog information may be associated to each OLED cell separately, be associated to each column of the OLED cells separately, be associated to multiple areas of the OLED cells separately or be associated to any other arrangement related the OLED cells. For example, in an OLED display, different areas may confront different levels of attenuation due to different use or other factors. Such characteristics may be considered to divide the OLED cells into multiple subsets and different compensations are applied to these subsets separately.

The compensation device may include a digital-to-analog converter for converting the adjustment data to analog data related to drive the OLED cells. The compensation device may include other corresponding circuits for achieving the driving function together.

When there are lot of OLED cells, adjustment data may occupy large space. The adjustment data may be compressed by the processor before sending to the OLED driver. When the OLED driver receives the compressed adjustment data, the OLED driver may use a corresponding decompressing circuit to decompress the compressed adjustment data so as to apply corresponding compensation and driving.

Please be noted that such compensation may be applied continuously during driving the OLED cells. Alternatively, such compensation may refer to set values in some registers or tables which are used as reference for generating the output driving signals or driving currents for the OLED cells.

The compensation may be applied periodically, automatically or manually when being requested by the user.

In addition, the OLED status information may include actual driving signal like driving current values and may also include optical information of the light emitted by the OLED cells. To achieve that, some optical sensors may be disposed to get the actual light output and such information is converted or integrated with the OLED status information to be sent to the processor.

Another embodiment of the present invention is an OLED driver to be used in an OLED apparatus. In other words, a manufacturer may produce the whole OLED apparatus, part of the OLED apparatus or just the OLED driver by using the inventive schemes as mentioned above.

Compared with applying compensation within the OLED driver, the embodiments mentioned above keep the OLED driver design simpler and thus reduces production cost and complexity. On the other hand, the processor usually has strong computation power while the compensation may not need to computed continuously. The computation work may be applied by the processor during free time or initialization time when the OLED apparatus is started. No further cost is used while the same task is done. In addition, memory saving is also achieved with compression and sharing designs as mentioned above.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. An OLED apparatus, comprising:
OLED cells;
an OLED driver to drive the OLED cells for rendering an image, the OLED driver having a status extraction device for obtaining OLED status information of the OLED cells and a compensation device for receiving adjustment data and using the adjustment data to adjust the driving of the OLED cells; and
a processer for generating the image, for receiving the OLED status information, for generating the adjustment data based on the OLED status information and for sending the adjustment data to the OLED driver.

2. The OLED apparatus of claim 1, wherein the processor has multiple circuits, one or more than one of the multiple circuits is responsible for generating the image and another of the multiple circuits is responsible for generating the adjustment data.

3. The OLED apparatus of claim 1, wherein the processor is the main processor of the OLED apparatus and the OLED driver is a module connected with the main processor via a signal interface.

4. The OLED apparatus of claim 1, further comprising a storage for storing reference data to be compared with the OLED status information for generating the adjustment data.

5. The OLED apparatus of claim 1, wherein the reference data are compressed when being stored in the storage.

6. The OLED apparatus of claim 1, wherein the adjustment data are compressed by the processor before sending to the OLED driver.

7. The OLED apparatus of claim 1, wherein the status extraction device comprises an analog-to-digital converter for converting analog data related to drive the OLED cells to digital values.

8. The OLED apparatus of claim 1, wherein the OLED status information are compressed when being sent to the processor.

9. The OLED apparatus of claim 1, wherein the compensation device comprises a digital-to-analog converter for converting the adjustment data to analog data related to drive the OLED cells.

10. The OLED apparatus of claim 1, wherein the OLED cells are divided into a plurality of subsets and the adjustment data are applied to each subset separately.

11. An OLED driver used in an OLED apparatus, comprising:
a driver device for driving the OLED to render an image requested by the processor;
a status extraction device for obtaining OLED status information of the OLED cells; and
a compensation device for receiving adjustment data and using the adjustment data to adjust the driving of the OLED cells, wherein the processer generates the image, receives the OLED status information, generates the adjustment data based on the OLED status information and sends the LED status information to the OLED driver.

12. The OLED driver of claim 11, further comprising a processor, the processor has multiple circuits, one or more than one of the multiple circuits is responsible for generating the image and another of the multiple circuits is responsible for generating the adjustment data.

13. The OLED driver of claim 12, wherein the processor is the main processor of the OLED apparatus and the OLED driver is a module connected with the main processor via a signal interface.

14. The OLED driver of claim 11, further comprising a storage for storing reference data to be compared with the OLED status information for generating the adjustment data.

15. The OLED driver of claim 14, wherein the reference data are compressed when being stored in the storage.

16. The OLED driver of claim 14, wherein the storage is outside the OLED driver and is also used for storing other data used by the processor for functions other than OLED displaying.

17. The OLED driver of claim 11, wherein the status extraction device comprises an analog-to-digital converter for converting analog data related to drive the OLED cells to digital values.

18. The OLED driver of claim 11, wherein the compensation device comprises a digital-to-analog converter for converting the adjustment data to analog data related to drive the OLED cells.

19. The OLED driver of claim 11, wherein the OLED cells are divided into a plurality of subsets and the adjustment data are applied to each subset separately.

20. The OLED driver of claim 11, wherein the adjustment data are compressed before sending to the compensation device and the compressed adjustment data are decompressed when the compensation device receives the compressed adjustment data.
